(19) United States
(12) Patent Application Publication
(10) Pub. No.: US 2005/0025998 A1
(43) Pub. Date: Feb. 3, 2005

(54) Data storage media having a sublayer containing a pigment combination having balanced pigment weight ratios

(75) Inventor: Richard M. Fuller, Lake Elmo, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/630,410

(22) Filed: Jul. 30, 2003

(51) Int. Cl. G11B 5/68; B32B 5/16

(52) U.S. Cl. 428/694 BS; 428/329; 428/212; 428/694 BU; 428/694 BB; 428/694 BN

(57) ABSTRACT

A dual-layer magnetic recording medium comprising a non-magnetic substrate having a front side and a back side, the front side having at least one lower support layer formed over the substrate and at least one magnetic upper layer formed over the at least one support layer, wherein the magnetic upper layer includes magnetic pigment particles having an average particle length of less than about 75 nanometers, and a binder system for the magnetic particles, and the lower support layer includes a pigment combination having a pigment weight ratio of from about 84% to about 92% alpha iron oxide, from about 1 to about 10 parts alumina per hundred parts alpha iron oxide, and from about 3 to about 15 parts carbon black per hundred parts alpha iron oxide, wherein the magnetic recording medium exhibits a resistivity of no more than about 1×10⁹ ohms/square.

### THE FIELD OF THE INVENTION

The present invention relates generally to magnetic recording media such as a magnetic tape, more specifically to a dual-layer magnetic medium having a magnetic upper layer, and a support layer or sublayer containing an optimized pigment formulation.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, magnetic recording media generally comprise a magnetic layer coated onto at least one side of a non-magnetic substrate (e.g., a film for magnetic recording tape applications).

Magnetic tapes may also have a backside coating applied to the opposing side of the non-magnetic substrate in order to improve the durability, electrical conductivity, and tracking characteristics of the media. As with the front coatings, the backside coatings are typically combined with a suitable solvent to create a homogeneous mixture which is then coated onto the substrate, after which the coating is dried, calendered if desired, and then cured.

In certain designs, the magnetic coating (or “front coating”) is formed as a single layer directly onto a non-magnetic substrate. In an effort to reduce the thickness of this magnetic recording layer, an alternative approach has been developed to form the front coating as a dual-layer construction, including a support layer (or “lower layer”) on the substrate and a magnetic layer (or “upper layer”) formed directly on the support or lower layer. With this construction, the lower layer is typically non-magnetic and generally comprised of a non-magnetic powder dispersed in a binder. Conversely, the upper layer comprises a magnetic metal particle powder or pigment dispersed in a binder.

The formulation for the support layer also comprises pigments and binders. Support layer formulations are important for finished tape properties such as smoothness, and conductivity of the tape. The proper conductivity values result in the dissipation of static electric charges, and serve as a buffer coating to reduce any effects of substrate film roughness and optimize such characteristics as signal-to-noise ratios.

It would therefore be desirable to have a magnetic recording medium which has an optimized support layer formulation for improved smoothness and conductivity. Optimizing pigment weight ratios in the support layer would contribute significantly to improvement of such properties.

### SUMMARY OF THE INVENTION

The invention provides a magnetic recording medium having a magnetic upper layer, and a support layer, or sublayer containing a non-magnetic pigment combination having an optimized pigment weight ratio. The magnetic upper layer contains a primary metallic particulate pigment having an average particle length of less than about 75 nanometers, and a binder system therefor. A back coating may be formed on the back surface of the substrate, such optional coating would comprise primarily carbon black dispersed in a binder.

Specifically, a dual-layer magnetic recording medium of the invention comprises a non-magnetic substrate having a front side and a back side, at least one lower support layer formed over the front side and at least one magnetic upper layer formed over said at least one lower layer, said magnetic upper layer comprising magnetic pigment particles having an average particle length of less than about 75 nanometers, and a binder system therefor, said lower support layer comprising a combination of pigments having a pigment weight loading of from about 84% to about 92% alpha iron oxide, from about 1 to about 10 parts alumina per hundred parts alpha iron oxide by weight, and from about 3 to about 15 parts, preferably from about 6 parts to about 15 parts carbon black per hundred parts alpha iron oxide,

wherein the magnetic recording medium exhibits a resistivity of no more than about 10⁹ ohms/square.

These terms when used herein have the following meanings.
1. The term “coating composition” means a composition suitable for coating onto a substrate.
2. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.
3. The term “resistivity” means the surface electrical resistance measured in Ohms/square.
4. The terms “layer” and “coating” are used interchangeably to refer to a coated composition.
5. The term “coercivity” means the intensity of the magnetic field needed to reduce the magnetization of a ferromagnetic material to zero after it has reached saturation, taken at a saturation field strength of 10,000 Oersteds.
6. The term “Oersted,” abbreviated as Oe, refers to a unit of magnetic field in a dielectric material equal to 1/μ Gauss, where μ is the magnetic permeability.

All weights, amounts and ratios herein are by weight, unless otherwise specifically noted.

### BRIEF DESCRIPTION OF THE DRAWING

FIG. 1 is a resistivity graph.

### DETAILED DESCRIPTION OF THE PREFERRED EMBODIMENTS

The following detailed description describes certain embodiments and is not to be taken in a limiting sense. The scope of the present invention is defined by the appended claims.

The magnetic recording medium includes a non-magnetic substrate, a magnetic upper layer, a lower support layer, or sub-layer, and optionally, a back coat layer. The various components are described in greater detail below. In general terms, however, the magnetic upper layer includes a primary magnetic metal pigment, and a binder for the pigment. The lower support layer includes a combination of pigments including a primary non-magnetic pigment, an electroconductive material such as carbon black material, and an alumina pigment dispersed in a binder system.

The Lower Layer or Support Layer

The lower or support layer of a dual-layer magnetic tape of the invention is essentially non-magnetic and includes non-magnetic powders, and a resin binder system. By forming the lower layer to be essentially non-magnetic, the electromagnetic characteristics of the upper magnetic layer are not adversely affected.

The lower layer of magnetic recording media of the invention includes a combination of pigments, which is balanced to provide optimal dispersion rheology for forming a smooth coating on the substrate, and optimal conductivity/resistivity for the resulting medium. Such support layers are used in combination with an upper magnetic layer to form a magnetic recording medium having a resistivity of no more than about 1×10⁹ ohms/square. The combination of pigments in support layers of dual-layer magnetic media of the invention includes at least a primary pigment material, conductive carbon black, and an alumina pigment. The primary lower layer pigment material consists primarily of non-magnetic particles. Non-magnetic particles such as iron oxides, titanium dioxide, titanium monoxide, alumina, tin oxide, titanium carbide, silicon carbide, silicon dioxide, silicon nitride, boron nitride, and the like.

In a preferred embodiment, the primary lower layer pigment material is a hematite material (α-iron oxide), which can be acidic or basic in nature. In one embodiment, alpha-iron oxides are substantially uniform in particle size. A metal-use starting material is dehydrated by heating, and annealed to reduce the number of pores. After annealing, the pigment is ready for surface treatment, which is typically performed prior to mixing with other layer materials such as carbon black and the like. Alpha-iron oxides are well known and are commercially available from Dowa Mining Company, Toda Kogyo, Sakai Chemical Industry Co., and others.

Conductive carbon black materials provide a certain level of conductivity so as to provide the formulation with protection from charging with static electricity. The conductive carbon black material is preferably of a conventional type and widely commercially available. In one preferred embodiment, the conductive carbon black material has an average particle size of less than 20 nm, more preferably about 15 nm.

The pigment combination for use in the support or lower layer also includes an alumina containing pigment. In a preferred embodiment, such pigment is an aluminum oxide pigment. Other abrasive grains such as silica, ZrO₂, Cr₂O₃, etc., can also be employed in mixtures with aluminum oxide, if additional granular pigments are desired. Such pigments are frequently referred to as head cleaning agents (HCA) due to the abrasive nature of the pigments.

In support layers of magnetic recording media of the invention, the pigment combination has been selected to optimize the pigment weight ratio. This selection results in improved smoothness, resistivity of the completed magnetic medium using the optimized support layer. Support layers of the invention comprise from about 84% to about 92% alpha iron oxide, from about 1 to about 10 parts of alumina per each hundred parts of alpha iron oxide by weight, and at from about 3 parts to about 15 parts, preferably from about 6 parts to about 15 parts of carbon black per each hundred parts alpha iron oxide by weight. Magnetic recording media formed using such support layers have a resistivity of no more than about 1×10⁹ ohms/square.

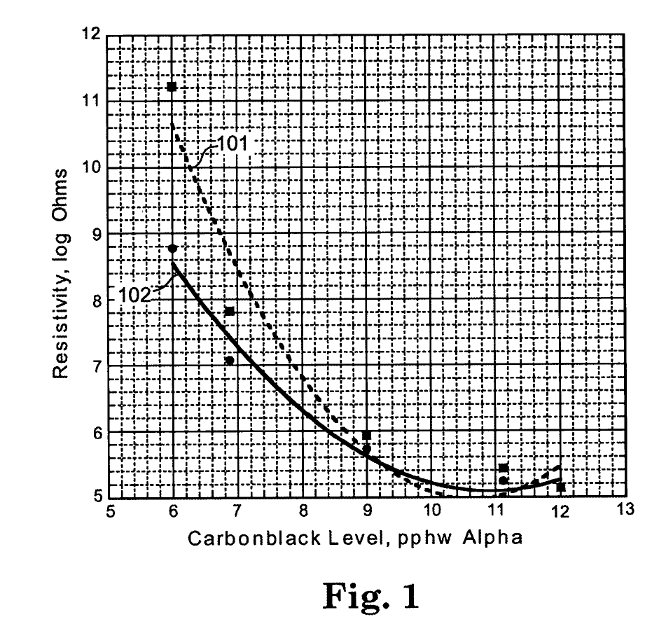

FIG. 1 shows resistivity curves obtained for magnetic recording media using two different hematites; curve 101 is the variation of resistivity of a magnetic recording medium containing a hematite pigment having an average particle length of less than 75 nm graphed per amount of carbon black added; curve 102 shows the resistivity of an magnetic recording medium containing a hematite having an average particle length less than 120 nm also plotted against the amount of carbon black.

The binder system or resin associated with the lower layer preferably incorporates at least one binder resin, such as a thermoplastic resin, in conjunction with other components. Additional components may include binders and surfactants used to disperse the HCA, a surfactant (or wetting agent), and one or more hardeners. In one preferred embodiment, the binder system of the lower layer includes at least one hard resin component and at least one soft resin component in conjunction with the other binder components, e.g., a combination of a primary polyurethane resin and a vinyl chloride resin. Examples of polyurethanes include polyether-polyurethane, polyester-poly-urethane, polycarbonate-polyurethane, polyester-polycarbonate-polyurethane, and polycaprolactone-polyurethane. Resins such as vinyl chloride-vinyl acetate copolymer, vinyl chloride-vinyl acetate-vinyl alcohol copolymer, and vinyl chloride-vinyl acetate-maleic anhydride can also be employed with the primary polyurethane binder, if desired.

In a preferred embodiment, a primary polyurethane binder is incorporated into the lower layer in an amount of from about 4 to about 10 parts by weight, and preferably from about 6 to about 8 parts by weight, based on 100 parts by weight of the primary lower layer pigment. In a preferred embodiment, the vinyl chloride binder is incorporated into the lower layer in an amount of from about 7 to about 15 parts by weight, and preferably from about 10 to about 12 parts by weight, based on 100 parts by weight of the primary lower layer pigment.

The coating composition further preferably includes an additional binder used to disperse the alumina material, such as a polyurethane paste binder (in conjunction with a pre-dispersed or paste alumina pigment.

The binder system may also contain a conventional surfactant or wetting agent. Known surfactants, e.g., adducts of sulfuric, sulfonic, phosphoric, phosphonic, and carboxylic acids, are acceptable.

The binder system may also contain a hardening agent such as isocyanate or polyisocyanate. In a preferred embodiment, the hardener component is incorporated into the lower layer in an amount of from about 2 to about 5 parts by weight, and preferably from about 3 to about 4 parts by weight, based on 100 parts by weight of the primary lower layer pigment.

The lower layer may further contain one or more lubricants such as a fatty acid and/or a fatty acid ester. In a preferred embodiment, the support layer includes a stearic acid which is at least about 90% pure. Although technical grade acids and/or acid esters can also be employed for the lubricant component, incorporation of high purity lubricant materials ensures robust performance of the resultant medium. Other acceptable fatty acids include myristic acid, palmitic acid, oleic acid; etc., and their mixtures. The support layer formulation can further include a fatty acid ester such as butyl stearate, isopropyl stearate, butyl oleate, butyl palmitate, butyl myristate, hexadecyl stearate, and oleyl oleate. The fatty acids and fatty acid esters may be employed singly or in combination. In a preferred embodiment, the lubricant is incorporated into the lower layer in an amount of from about 1 to about 10 parts by weight, and preferably from about 1 to about 5 parts by weight, based on 100 parts by weight based on the primary lower layer pigment combination.

The materials for the lower layer are mixed with the primary pigment and the lower layer is coated onto the substrate. Useful solvents associated with the lower layer coating material preferably include cyclohexanone (CHO), with a preferred concentration of from about 5% to about 50%, methyl ethyl ketone (MEK) preferably having a concentration of from about 30% to about 90%, and toluene (Tol), of concentrations from about 5% to about 90%. Alternatively, other ratios can be employed, or even other solvents or solvent combinations including, for example, xylene, methyl isobutyl ketone, tetrahydrofuran, and methyl amyl ketone.

The Magnetic Recording Layer

In accordance with the current invention, the upper layer of the medium is a magnetic recording layer. The magnetic recording layer is a thin layer, being preferably from about 1 microinch (0.025 μ) to about 10 microinches (0.25 μ) in thickness, preferably from about 1 microinch to about 8 microinches.

The magnetic metal particle pigments have a composition including, but not limited to, metallic iron and/or alloys of iron with cobalt and/or nickel, and magnetic or non-magnetic oxides of iron, other elements, or mixtures thereof Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length no greater than about 75 nanometers (nm). Such pigments are readily commercially available from companies such as Toda Kogyo, Kanto Denka Kogyo, and Dowa Mining Company.

In addition to the preferred primary magnetic metal particle pigment described above, the upper layer further includes soft spherical particles. Most commonly, these particles are comprised of carbon black. A small amount, preferably less than about 3%, of at least one large particle carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the upper layer are small carbon particles, i.e., the particles have a particle size on the order of less than 100 nm, preferably less than about 50 nm.

The magnetic upper layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The binder system associated with the upper layer preferably incorporates at least one binder resin, such as a thermoplastic resin, in conjunction with other resin components such as binders and surfactants used to disperse the HCA, a surfactant (or wetting agent), and one or more hardeners. In one preferred embodiment, the binder system of the upper layer includes at least one hard resin component and at least one soft resin component in conjunction with the other binder components. Hard resin components typically have a glass transition temperature (Tg) of at least about 70° C., and soft resin components typically have a glass transition temperature of less than about 68° C.

One useful combination combines a polyurethane resin and a vinyl chloride resin. Examples of polyurethanes include polyether-polyurethane, polyester-polyurethane, polycarbonate-polyurethane, polyester-polycarbonate-polyurethane, and polycaprolactone-polyurethane. Resins such as vinyl chloride-vinyl acetate copolymer, vinyl chloride-vinyl acetate-vinyl alcohol copolymer, and vinyl chloride-vinyl acetate-maleic anhydride can also be employed with the primary polyurethane binder, if desired.

In one preferred embodiment, the primary polyurethane binder is incorporated into the upper layer in an amount of 4 to 10 parts by weight, and preferably 5 to 7 parts by weight, based on 100 parts by weight of the primary upper layer pigment, and the vinyl chloride binder is incorporated in an amount of 7 to 15 parts by weight, and preferably 10 to 12 parts by weight, based on 100 parts by weight of the primary upper layer pigment.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable. As with other ingredients, HCA may be added to the main dispersion separately or dispersed in the binder system, and then added to the main dispersion.

The magnetic upper layer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in both the upper and lower layers are preferably selected and formulated in combination. Preferred fatty acid lubricants include the at least 90 percent pure stearic acid as discussed for the support layer. Likewise, other acceptable fatty acids include one or more of myristic acid, palmitic acid, oleic acid, etc., and their mixtures. The upper layer formulation can further include one or more fatty acid esters such as butyl stearate, isopropyl stearate, butyl oleate, butyl palmitate, butyl myristate, hexadecyl stearate, and oleyl oleate.

In a preferred embodiment, the lubricant is incorporated into the upper layer in an amount of from about 1 to about 10 parts by weight, and preferably from about 1 to about 5 parts by weight, based on 100 parts by weight of the primary pigment.

The binder system may also contain a conventional surfactant or wetting agent. Known surfactants, e.g., adducts of sulfuric, sulfonic, phosphoric, phosphonic, and carboxylic acids, are acceptable.

The coating composition may also contain a hardening agent such as isocyanate or polyisocyanate. In a preferred embodiment, the hardener component is incorporated into the upper layer in an amount of from about 1 to about 5 parts by weight, and preferably from about 1 to about 3 parts by weight, based on 100 parts by weight of the primary magnetic pigment.

The materials for the upper layer are mixed with the primary pigment and coated atop the lower layer. Useful solvents associated with the upper layer coating material preferably include cyclohexanone (CHO), with a preferred concentration of from about 5% to about 50%, methyl ethyl ketone (MEK) preferably having a concentration of from about 30% to about 90%, and toluene (Tol), of concentrations from about 0% to about 40%. Alternatively, other ratios can be employed, or even other solvents or solvent combinations including, for example, xylene, methyl isobutyl ketone, tetrahydrofuran, and methyl amyl ketone.

The Back Coat

The back coat, when used, is generally of a type conventionally employed, and thus primarily consists of a soft non-magnetic particle material such as carbon black or silicone dioxide particles. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 50 nm, whereas the secondary, large carbon component preferably has an average particle size on the order of from about 50 to about 300 nm. The back coat of the magnetic recording medium of the present invention contains from about 25 to about 50 percent small particle carbon particles based on total composition weight, preferably from about 35 to about 50 percent based on total composition weight.

Back coat pigments are dispersed as inks with appropriate binders, surfactant, ancillary particles, and solvents. Preferably, the back coat binder includes at least one of a polyurethane resin, a phenoxy resin, and nitrocellulose blended appropriately to modify coating stiffness as desired.

Substrate

The substrate can be any conventional non-magnetic substrate useful as a magnetic recording medium support. Exemplary substrate materials useful for magnetic recording tapes include polyesters such as polyethylene terephthalate, polyethylene naphthalate (PEN), a mixture of polyethylene terephthalate and polyethylene naphthalate; polyolefins (e.g., polypropylene); cellulose derivatives; polyamides; and polyimides. In a preferred embodiment, polyethylene naphthalate (PEN) is employed.

Process for Manufacture

The coating materials of the upper layer, lower layer, and back coat according to the present invention are prepared by dispersing the corresponding powders or pigments and the binders in a solvent. For example, with respect to the coating material for the upper layer, the primary metal particle powder or pigment and the large particle carbon materials are placed in a high solids mixing device along with certain of the resins (i.e., polyurethane binder, vinyl chloride binder, and surfactant) and the solvent, and processed for from about 1 to about 4 hours. The resulting material is processed in a high-speed impeller dissolver for about 30 to about 90 minutes, along with additional amounts of the solvent. Following this letdown processing, the resulting composition is subjected to a sandmilling or polishing operation. Subsequently, the HCA and related binder components are added, and the composition left standing for about 30 to about 90 minutes. Following this letdown procedure, the composition is processed through a filtration operation, and then stored in a mixing tank at which the hardener component and lubricants are added. The resulting upper layer coating material is then ready for coating.

Preparation of the lower layer coating material preferably entails a similar process, including high solids mixing of the pigment combination including the primary lower layer pigment, the conductive carbon black material, and the alumina with the binder resins including the primary polyurethane binder and vinyl chloride binder and a solvent, for about 2 to 4 hours.

Finally, preparation of the back coat coating material preferably entails mixing the various components, including a solvent, in a planetary mixer or similar device, and then subjecting the dispersion to a sandmilling operation. Subsequently, the material is processed through a filtration operation in which the material is passed through a number of filters.

The process for manufacture of the magnetic recording medium may include an in-line portion and one or more off-line portions. The in-line portion includes unwinding a non-magnetic substrate or other material from a spool or supply. The substrate is coated with the backcoating on one side of the substrate. Next the backside coating is dried, typically using conventional ovens. A front coating is applied to the substrate; for the dual-layer magnetic recording media of the invention, the sublayer or support layer is applied first, directly onto the substrate, and the magnetic coating is then coated atop the support layer. Alternatively, the dual-layer front coating can occur prior to the backcoating. The coated substrate is magnetically oriented and dried, and then proceeds to the in-line calendaring station. According to one embodiment, called compliant-on-steel (COS), in-line calendering uses one or more in-line nip stations, in each of which a steel or other generally non-compliant roll contacts or otherwise is applied to the magnetically coated side of the substrate, and a rubberized or other generally compliant roll contacts or otherwise is applied to the backcoated side. The generally non-compliant roll provides a desired degree of smoothness to the magnetically coated side of the substrate. Alternately, the in-line calendering is “steel-on-steel,” (SOS), meaning both opposing rolls are steel. The process may also employ one or more nip stations each having generally non-compliant rolls. After in-line calendaring, the substrate or other material is wound. The process then proceeds to an off-line portion which occurs at a dedicated stand-alone machine. The coated substrate is unwound and then is calendered. The off-line calendering includes passing the coated substrate through a series of generally non-compliant rollers, e.g., multiple steel rollers, although materials other than steel may be used. The coated, calendered substrate then is wound a second time. The wound roll is then slit, burnished, and tested for defects according to methods known in the industry.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in: the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof

### EXAMPLES

Sample magnetic recording media 1-23 were made as noted below using different weights of pigments in the sublayer. The term “Alpha 1” refers to a hematite pigment having an average particle length less than 75 nm; “Alpha 2” refers to a hematite pigment having an average particle length less than 120 nm. The term “pphw” means parts per hundred weight. 45 degree gloss was measured using a Gardner Microgloss™ Glossmeter with a 45 degree incident light beam. The caliper is measured twice; “BST,” which means “before surface treatment,” and “AST,” which means “after surface treatment.” The reference to surface treatment is a reference to the calendering process.

TABLE 1

| | | | | Pigment Weight Ratio | | | | | | | |
|---|---|---|---|---|---|---|---|---|---|---|---|
| | Pigments in pphwA | | | | | | 45 Deg | Resistivity | Caliper, microinches | | |
| Sample | Alpha 1 | Carbon | Alumina | Alpha 1 | Carbon | Alumina | Gloss | logOHM | BST | AST | % Comp |
| 1 | 100 | 6.9 | 2.2 | 91.7 | 6.3 | 2.0 | 80.8 | 7.72 | 132.8 | 122.0 | 8.1 |
| 2 | 100 | 6.9 | 7.8 | 87.2 | 6.0 | 6.8 | 80.4 | 8.40 | 116.5 | 111.0 | 4.7 |
| 3 | 100 | 11.1 | 2.2 | 88.3 | 9.8 | 1.9 | 73.3 | 5.39 | 134.1 | 118.8 | 11.5 |
| 4 | 100 | 11.1 | 7.8 | 84.1 | 9.3 | 6.6 | 73.3 | 5.54 | 169.5 | 144.4 | 14.8 |
| 5 | 100 | 9.0 | 5.0 | 87.7 | 7.9 | 4.4 | 78.0 | 5.94 | 149.4 | 125.0 | 16.3 |
| 6 | 100 | 6.0 | 5.0 | 90.1 | 5.4 | 4.5 | 81.6 | 11.22 | 135.3 | 120.1 | 11.2 |
| 7 | 100 | 12.0 | 5.0 | 85.4 | 10.3 | 4.3 | 73.6 | 5.14 | 156.5 | 132.9 | 15.1 |
| 8 | 100 | 9.0 | 1.0 | 90.9 | 8.2 | 0.9 | 78.3 | 5.85 | 141.6 | 126.9 | 10.4 |
| 9 | 100 | 9.0 | 9.0 | 84.8 | 7.6 | 7.6 | 75.0 | 6.04 | 143.8 | 117.0 | 18.6 |
| 10 | 100 | 6.9 | 2.2 | 91.7 | 6.3 | 2.0 | 82.8 | 7.33 | 150.8 | 127.3 | 15.6 |
| 11 | 100 | 11.1 | 7.8 | 84.1 | 9.3 | 6.6 | 75.6 | 5.37 | 170.4 | 130.1 | 23.6 |
| 12 | 100 | 9.0 | 5.0 | 87.7 | 7.9 | 4.4 | 77.3 | 5.90 | 154.0 | 130.6 | 15.2 |
| | Pigments in pphwA | | | Pigment Weight Ratio | | | 45 Deg | Resistivity | Caliper, microinches | | |
| Sample | Alpha 2 | Carbon | Alumina | Alpha 1 | Carbon | Alumina | Gloss | logOHM | BST | AST | % Comp |
| 13 | 100 | 6.9 | 2.2 | 91.7 | 6.3 | 2.0 | 114.9 | 7.18 | 129.8 | 114.0 | 12.1 |
| 14 | 100 | 6.9 | 7.8 | 87.2 | 6.0 | 6.8 | 109.1 | 7.24 | 127.5 | 113.8 | 10.8 |
| 15 | 100 | 11.1 | 2.2 | 88.3 | 9.8 | 1.9 | 100.5 | 5.24 | 139.3 | 119.1 | 14.5 |
| 16 | 100 | 11.1 | 7.8 | 84.1 | 9.3 | 6.6 | 99.5 | 5.28 | 141.5 | 114.9 | 18.8 |
| 17 | 100 | 9.0 | 5.0 | 87.7 | 7.9 | 4.4 | 108.2 | 5.80 | 140.9 | 111.9 | 20.6 |
| 18 | 100 | 6.0 | 5.0 | 90.1 | 5.4 | 4.5 | 116.2 | 8.77 | 127.5 | 118.3 | 7.3 |
| 19 | 100 | 12.0 | 5.0 | 85.4 | 10.3 | 4.3 | 96.7 | 5.14 | 148.8 | 124.3 | 16.5 |
| 20 | 100 | 9.0 | 1.0 | 90.9 | 8.2 | 0.9 | 110.0 | 5.49 | 146.4 | 127.5 | 12.9 |
| 21 | 100 | 9.0 | 9.0 | 84.8 | 7.6 | 7.6 | 106.2 | 5.87 | 141.0 | 109.4 | 22.4 |
| 22 | 100 | 6.9 | 2.2 | 91.7 | 6.3 | 2.0 | 113.6 | 6.82 | 139.3 | 119.4 | 14.3 |
| 23 | 100 | 11.1 | 7.8 | 84.1 | 9.3 | 6.6 | 97.8 | 5.19 | 148.8 | 130.1 | 12.5 |

1. A dual-layer magnetic recording medium comprising a non-magnetic substrate having a front side and a back side, at least one lower support layer formed over the front side and at least one magnetic upper layer formed over said at least one lower layer, said magnetic upper layer comprising magnetic pigment particles having an average length of less than about 75 nanometers, and a binder system therefor, said lower support layer comprising a pigment combination having a pigment weight ratio of from about 84% to about 92% alpha iron oxide, from about 1 to about 10 parts alumina per hundred parts alpha iron oxide by weight, and from about 3 parts to about 15 parts carbon black per hundred parts alpha iron oxide by weight,
wherein the magnetic recording medium exhibits a resistivity of no more than about 1×10⁹ ohms/square.

2. A dual-layer magnetic recording medium according to claim 1, wherein said lower support layer comprises from about 6 parts to about 15 parts carbon black per hundred parts alpha iron oxide by weight.

3. A dual-layer magnetic recording medium according to claim 1, wherein said support layer comprises an aluminum oxide in said pigment combination.

4. A dual-layer magnetic recording medium according to claim 1, wherein said resistivity is from about 10⁴ ohms/sq to about 10⁹ ohms/sq.

5. A dual-layer magnetic recording medium according to claim 1, wherein said lower support layer further comprises a binder system for said pigment combination.

6. A dual-layer magnetic recording medium according to claim 5, wherein said binder system comprises a hard resin component and a soft resin component.

7. A dual-layer magnetic recording medium according to claim 6, wherein the hard resin has a Tg of greater than about 70° C.

8. A dual-layer magnetic recording medium according to claim 6, wherein the soft resin has a Tg of less than about 68° C.

9. A dual-layer magnetic recording medium according to claim 6, wherein said soft resin component is a polyurethane resin.

10. A dual-layer magnetic recording medium according to claim 6, wherein said hard resin component is a vinyl chloride resin.

11. A dual-layer magnetic recording medium according to claim 6, wherein said hard resin component is a non-halogenated vinyl resin.

12. A dual-layer magnetic recording medium according to claim 1, wherein said lower layer further includes a fatty acid ester lubricant and a fatty acid lubricant.

13. A dual-layer magnetic recording medium according to claim 12, wherein said fatty acid lubricant comprises a stearic acid.

14. A dual-layer magnetic recording medium according to claim 13, wherein said stearic acid is at least about 90% pure.

15. A dual-layer magnetic recording medium according to claim 1, wherein said topmost magnetic layer has a thickness of from about 0.025 micron to about 0.25 micron.

16. A dual-layer magnetic recording medium according to claim 1, wherein said primary magnetic pigment particles have a coercivity of at least about 2000 Oersteds.

17. A dual-layer magnetic recording medium according to claim 16, wherein said primary magnetic pigment particles have a coercivity of at least about 2300 Oersteds.

18. A dual-layer magnetic recording medium according to claim 1, wherein said binder system for said primary magnetic particles in said magnetic upper layer comprises a hard resin component and a soft resin component.

19. A dual-layer magnetic recording medium according to claim 18, wherein the hard resin has a Tg of greater than about 70° C.

20. A dual-layer magnetic recording medium according to claim 18, wherein the soft resin has a Tg of less than about 68° C.

21. A dual-layer magnetic recording medium according to claim 18, wherein said soft resin component is a polyurethane resin, and said hard resin component is a vinyl chloride resin.

22. A dual-layer magnetic recording medium according to claim 18, wherein said hard resin component is a non-halogenated vinyl resin.

23. A dual-layer magnetic recording medium according to claim 1, wherein said magnetic recording layer further comprises a large carbon particle material.

24. A dual layer magnetic recording medium according to claim 1, wherein the upper layer comprises a primary ferromagnetic pigment, aluminum oxide, a spherical large particle carbon material, a polyurethane binder, a vinyl chloride binder, a hardener, a fatty acid ester lubricant, and a fatty acid lubricant.

25. A dual-layer magnetic recording medium according to claim 1, further comprising a back coat coated on said back side of said substrate.

26. A dual-layer magnetic recording medium according to claim 26, wherein the back coat includes a carbon black pigment, a urethane binder, and at least one compound selected from phenoxy resin and nitrocellulose.

27. A magnetic recording medium according to claim 26, wherein the backcoat further comprises carbon black, and a metal oxide selected from titanium dioxide, aluminum oxide and a mixture thereof.
